(19) United States
(12) Patent Application Publication
(10) Pub. No.: US 2004/0121161 A1
(43) Pub. Date: Jun. 24, 2004

(54) Composite material and mold process for injected molded vanity or countertop

(76) Inventors: Craig T. Shugert, Mission Viejo, CA (US); Frances Vincent P. Cabrera, Irvine, CA (US); Craig A. Arsenault, Monarch Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/327,021

(22) Filed: Dec. 20, 2002

(51) Int. Cl. B29C 45/16; B28B 7/22

(52) U.S. Cl. 428/423.1; 264/255

(57) ABSTRACT

Provided herein is a molded vanity top with a surface layer and a composite backing. The backing is made from a polyurethane resin and a filler, which may be any material compatible with the polyurethane resin. The filler is preferably sand and makes-up up to about 85% by weight of the backing. The disclosed vanity tops have the substantial weight and solid sound preferred by consumers, yet are often lighter and stronger than cultured marble vanity tops. Also provided herein is a method of manufacturing a molded vanity top. The interior of a mold is coated with a surface layer. The mold is then filled with a composite backing material made from a polyurethane resin and a filler. After curing, the vanity top is demolded and finished.

### BACKGROUND OF THE INVENTION

1. Technical Field of the Invention

The present application relates generally to molded vanity tops, and in particular, to composite vanity tops with urethane backings.

2. Description of the Related Art

Stone vanity tops are attractive, durable, water resistant, and temperature resistant. Stone is difficult to fabricate, however, which increases the cost of the vanity top. Moreover, the stone itself may be expensive. Stone is also heavy and susceptible to breakage. Vanity tops simulating the appearance of stone, for example marble or granite, are popular with consumers. Two types of simulated stone vanity tops are traditional solid surface and cultured marble molded tops.

A traditional solid surface vanity top does not have any layers and is homogeneous throughout. Accordingly, the composition of a solid surface vanity top is uniform throughout. Corian® (Dupont) is one example of a solid surface material. An advantage of a solid surface material is that scratches or burns and other minor surface damage may be sanded or buffed out, restoring the appearance of the surface. A disadvantage of solid surface materials is cost. Traditional solid surface material is expensive and expensive to manufacture into vanity tops. The material is supplied in sheets, which must be cut, glued, and sanded to fabricate a finished vanity top. The fabrication process is generally very labor intensive and adds to the cost of the finished product.

Cultured marble vanity tops possess a thin surface (veneer) layer with the desired appearance, for example, simulated stone or a shiny white gelcoat. The surface layer is typically a polyester gelcoat. The interior, or backing, is an inexpensive mixture of materials, typically about 15-35% polyester, and 65-85% calcium carbonate or other suitable filler material. The densities of cultured marble vanity tops are typically from about 100 lb/ft³ to about 130 lb/ft³. Because they are so dense, these vanity tops are very heavy, increasing both shipping costs and potential injuries during installation. Supporting this weight also requires a substantial support structure, for example the vanity base. The great weight makes very large items, for example, kitchen countertops, impractical to manufacture and install. Another disadvantage of a cultured marble vanity top is that it often shatters when dropped. Cultured marble vanity tops may be manufactured either using open mold or closed mold processes.

In an open or one-piece mold process, the interior of the mold corresponds to the top surface and edges of the vanity top. A surface layer, for example a polyester gelcoat, is applied to the interior surfaces of the mold. This surface layer can vary from 0.008 inches to 0.045 inches in thickness. The mold is then filled with the backing (matrix) material. After curing, the vanity top is demolded and finished.

A closed mold completely encases the molded item, defining the dimensions of the vanity top. Accordingly, the molding surface of a closed mold is constructed from at least two-pieces. For example, in a typical two-piece closed mold, the interior of a bottom mold corresponds to the top surface, the interior of the bowl, and edges of the vanity top. The interior of a top mold, or hat, corresponds to the bottom of the bowl and the bottom surface of the vanity top. In the manufacturing process, the mold is first opened and the interior surfaces of the bottom and top molds sprayed with a thin layer of a surface substrate such as a gelcoat. The bottom mold is then filled with the backing material. The hat is fitted onto the bottom mold and the amount of backing material is adjusted to completely fill the mold. The hat has an opening that corresponds to the drain of the bowl through which backing material may be added or removed. The vanity top is then cured, removed from the mold, and finished.

### SUMMARY OF THE INVENTION

Cultured marble vanity tops made according to the processes described above are less expensive than either natural stone or solid surface vanity tops. Consumers prefer vanity tops that simulate stone both in appearance and sound. A vanity top, when tapped, should sound solid rather than hollow or “plastic.” The sound is related to the density of the vanity top, with denser materials sounding more solid. As discussed above, however, very dense materials result in heavy vanity tops and their attendant problems. On the other hand, vanity tops that are too light can feel “cheap.” Because the surface layer comprises only a small fraction of the volume of a vanity top, the simplest method of modifying the density of a molded vanity top is to modify the backing. A properly formulated backing with a density of at least about 30 lb/ft³ provides products with suitable heft and solid sound.

Polyurethane or urethane is an attractive alternative to polyester for the backing. The manufacturing process is easier because the resin is injected into the mold rather than cast. The manufacturing process is also faster: the fastest polyester resin has a gel time of about 3 minutes, while urethane resins have a gel/cream time of about 60 seconds. Vanity tops made from urethane are also stronger and more durable than comparable polyester products. Urethane products are also lighter, facilitating handling in the plant and in the field. The densities of unfilled, expandable polyurethanes drop to about 8-70 lb/ft³ upon curing, however, because the polyurethanes foam from gas that is often generated in the curing process. Non-expandable, or solid, polyurethanes do not expand on curing, but are expensive, negating the advantage of a molded vanity top.

We have discovered that a composite backing made from a polyurethane resin and a high percentage by weight of a filler provides a vanity top with the desired density and sound characteristics. The disclosed vanity tops are stronger and lighter than the cultured marble vanity tops that they replace.

A first embodiment of the present invention provides a molded vanity top having a surface layer and a backing, wherein the backing comprises a polyurethane resin and a filler. In a preferred embodiment, the surface layer is a polyester-based resin or a polyurethane-based resin. The polyurethane resin may be an expandable polyurethane resin or a non-expandable polyurethane resin. The density of the unfilled polyurethane resin is preferably greater than about 50 lb/ft³, more preferably from about 65 lb/ft³ to about 85 lb/ft³. Preferred fillers include calcium carbonate, ground polycarbonate, other ground plastics, sawdust, particle board, MDF, sand, plaster sand, turf sand, silica sand, construction sand, industrial sand, commercial sand, small aggregate rocks, glass mirror, calcium sulfate, rubber, and combinations thereof. More preferred fillers include silica sand, calcium carbonate and commercial/industrial sand, which includes plaster sand or turf sand. The backing is preferably from about 10% to about 85% by weight filler, more preferably, from about 65% to about 85% by weight filler. The density of the vanity top is preferably from about 30 lb/ft³ to about 130 lb/ft³, more preferably, from about 45 lb/ft³ to about 110 lb/ft³, most preferably, from about 80 lb/ft³ to about 110 lb/ft³. The vanity top is preferably from about 0.25 inches to about 2 inches thick. In some embodiments, the vanity top further comprises a bowl or a backsplash, or both. In other embodiments, the vanity top comprises a sidesplash, which may be produced in a separate mold.

A second embodiment provides a molded vanity top having a polyester-based resin surface layer and a backing, wherein the backing comprises from about 35% to about 15% by weight of a polyurethane resin and from about 65% to 85% of sand.

A third embodiment provides a molded vanity top having a polyurethane-based resin surface layer and a backing, wherein the backing comprises from about 35% to about 15% by weight of a polyurethane resin and from about 65% to 85% of sand.

A fourth embodiment provides a method of manufacturing a molded vanity top with at least the steps of applying a surface material to an interior surface of a mold and filling the mold with a composite backing material, wherein the backing material comprises a polyurethane resin and a filler, and wherein the polyurethane resin comprises a isocyanate and a polyol. In a preferred embodiment, the mold is a closed mold. Preferably, the mold has one or more weepholes. In another preferred embodiment, the mold is filled until a small amount of the backing material is visible in the weephole. In another preferred embodiment, the backing material is injected into the mold. The backing material may be mixed and injected with a mixing head. Alternatively, the backing material is mixed and injected with a continuous caster. In yet another preferred embodiment, the filler is premixed with the polyol. The mold may be oriented in a horizontal position, in an inclined position, or in a vertical position.

A fifth embodiment provides a method of manufacturing a molded vanity top with at least the steps of spraying a polyester-based resin surface layer onto an interior surface of a closed mold; closing the mold; mixing and injecting a composite backing material into the mold with a continuous caster, wherein the backing comprises from about 35% to about 15% by weight of a polyurethane resin and from about 65% to 85% of sand, and wherein the polyurethane resin comprises a isocyanate and a polyol; curing the backing material; and demolding the vanity top.

A sixth embodiment provides a method of manufacturing a molded vanity top with at least the steps of spraying a polyurethane-based resin surface layer onto an interior surface of a closed mold; closing the mold; mixing and injecting a composite backing material into the mold with a continuous caster, wherein the backing comprises from about 35% to about 15% by weight of a polyurethane resin and from about 65% to 85% of sand, and wherein the polyurethane resin comprises a isocyanate and a polyol; curing the backing material; and demolding the vanity top.

### BRIEF DESCRIPTION OF THE FIGURES

FIG. 1A and FIG. 1B are illustrations of a three-piece, closed mold suitable for producing urethane composite vanity tops in an open and closed configuration, respectively.

FIG. 2A and FIG. 2B illustrate a closed mold in an inclined position and in a vertical position, respectively.

FIG. 3 illustrates a composite vanity top.

### DETAILED DESCRIPTION OF THE PREFERRED EMBODIMENTS

As used herein, the term vanity top refers to all substantially sheet-like products that may be manufactured according to the teachings of this disclosure. Accordingly, the term vanity top includes, for example, countertops, table tops, wall panels, building panels, mantles, sills, and the like. A vanity top may also include features that extend out of the plane of the product, for example, bowls or basins, or backsplashes. In another preferred embodiment, the vanity top includes a sidesplash. All percentages are by weight, unless otherwise specified.

The disclosed method may be used to manufacture vanity tops desirably from about 0.25 inches to about 2.0 inches thick.

The novel method disclosed herein provides a composite polyurethane backed vanity top with a density desirably of at least about 30 lb/ft³. Preferably, the density of the vanity top is from about 30 lb/ft³ to about 130 lb/ft³, more preferably, from about 45 lb/ft³ to about 110 lb/ft³, most preferably, from about 80 lb/ft³ to about 110 lb/ft³. Vanity tops fabricated according to the disclosed method within these density ranges have the desired sound and weight characteristics preferred by consumers. A vanity top manufactured by the disclosed method is also more durable than a vanity top made with filled polyester backing. For example, vanity tops manufactured according to the disclosed method have survived drops that would shatter a cultured marble vanity tops. Furthermore, grinding a composite urethane-backed vanity top results in less chipping of the surface edges, and less wear to the grinding equipment compared with a filled polyester-backed vanity top.

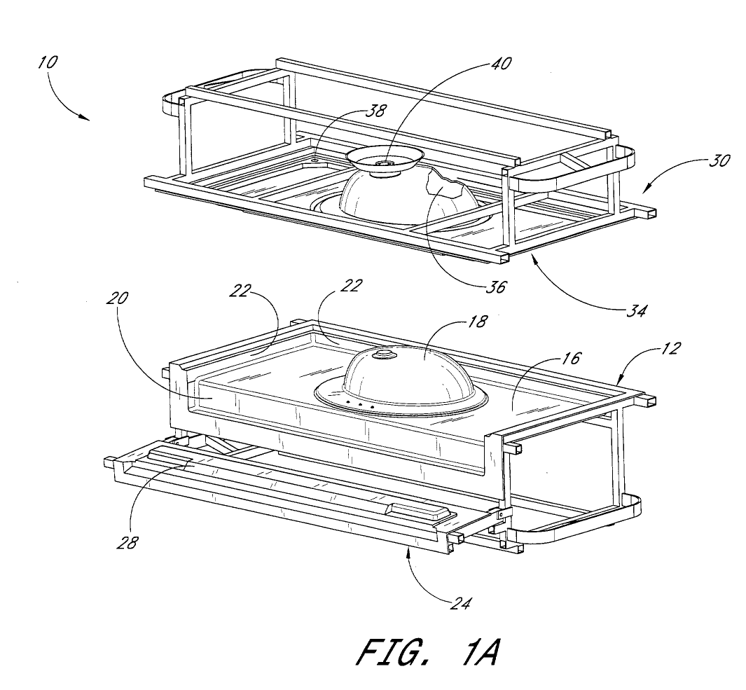

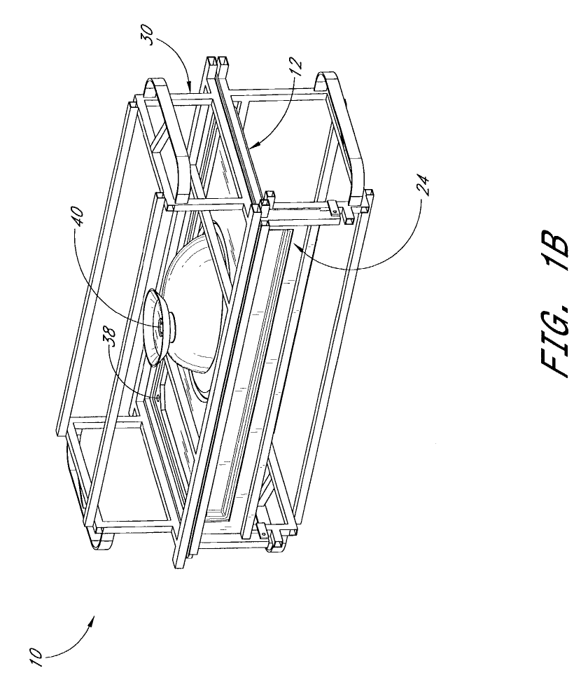

FIG. 1A illustrates a three-piece closed mold in an open configuration, in which a preferred embodiment of the disclosed method may be practiced. Materials suitable for the construction of molds for vanity tops are well-known in the art, for example, aluminum. stainless-steel, and fiberglass composites. The mold 10 provides a vanity top with a bowl and a backsplash. The three-piece mold 10 has a bottom mold 12. The interior of the bottom mold 12 comprises surfaces defining the top of the vanity top 16, the interior of a bowl 18, the front of a backsplash 20, and the front and side edges of the vanity top 22. The back of the backsplash 28 is defined by the interior surface of a back mold 24. The interior of a top mold 30, or hat, comprises surfaces defining the bottom of the vanity top 34 and the bottom of the bowl 36. In the illustrated embodiment, a weep hole 38 is provided at each corner of the top mold 30. The composite polyurethane resin is injected into the mold 10 through a port 40 located in this case at the bottom of the bowl.

A vanity top as disclosed herein may be manufactured in the mold illustrated in FIG. 1 as follows. A mold is selected that will produce a vanity top with the desired dimensions and features. The mold 10 is first opened as shown in FIG. 1A. If desired, a mold release may be applied to the interior surfaces the mold 10, in this case, the bottom mold 12, back mold 24, and top mold 30. The interior surfaces are then coated with a surface layer. The surface layer should release from the mold after the vanity top is cured. Suitable surfaces layers for molded vanity tops are well known in the art and include polyester-based resins, urethane-based resins, vinyl ester coatings, and acrylic coatings. Examples of polyester-based resin surface layers include polyester gelcoats, pigmented polyester gelcoats, particulate-filled polyester gelcoats, general purpose polyester resin, and fire retarding polyester resin. Examples of urethane-based resin surface layers include aliphatic urethane coatings and pigmented urethane coatings. Polyester-based gelcoats are the preferred surface layers for low-cost applications.

The interior surfaces of the mold 10 may be coated by any method that provides a satisfactory finish, for example, by spraying, brushing, powder coating, curtain extruding, hand rolling or injection coating. Preferably, the surface layer is applied by spraying. Different pieces of the mold or even different areas of the same piece of the mold may be coated with different surface layers. The surface layer may be applied as a single layer or as two or more layers. The thickness of the surface layer will vary with the application. A polyester gelcoat is preferably from about 0.0080 inches (8 mils) to about 0.045 inches (45 mils) thick. The mold 10 is maintained in the open position until the gelcoat is nearly cured, preferably, at about 85-95° F.

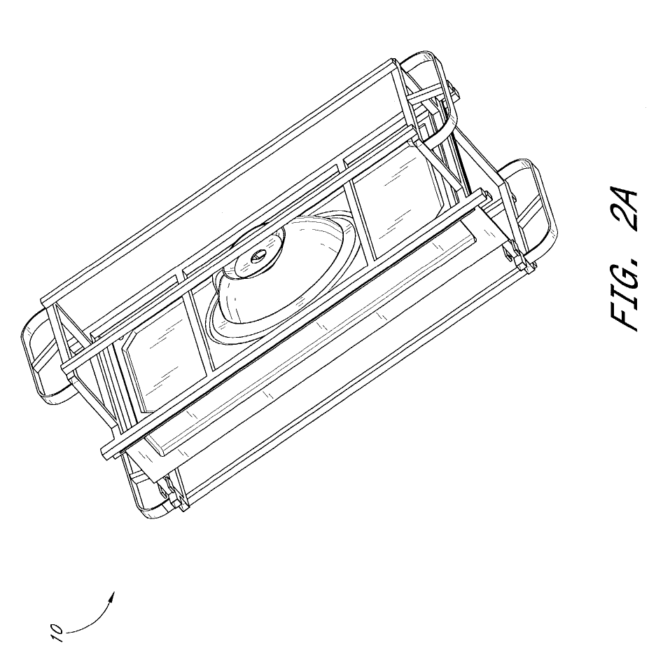

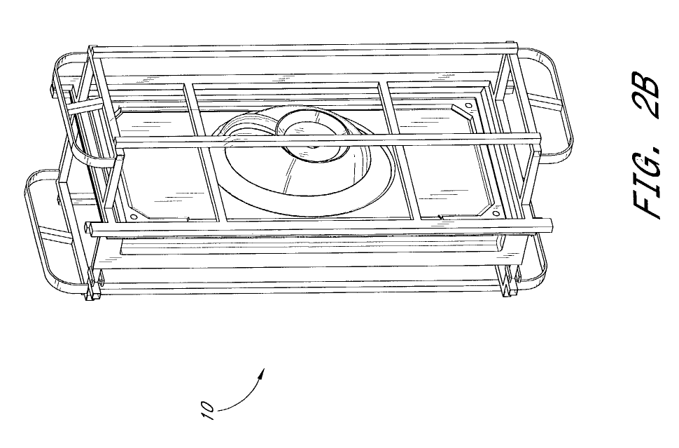

The mold 10 is then closed as shown in FIG. 1B. The mold 10 is filled with a composite polyurethane resin through port 40. In another embodiment, the closed mold is filled in an inclined position, as illustrated in FIG. 2A, or in a vertical position as shown in FIG. 2B.

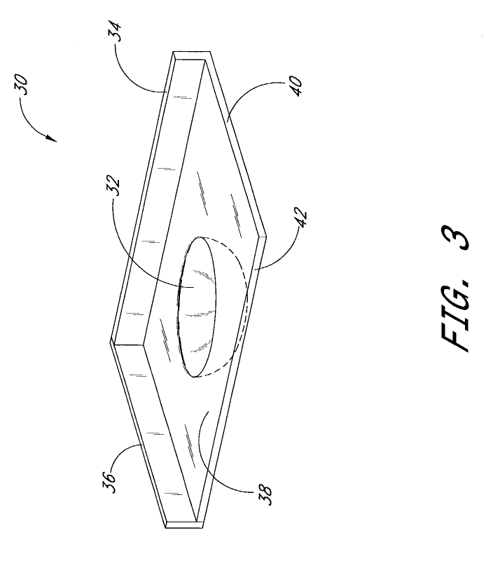

As shown in FIG. 3, a vanity top 30 may include a bowl or basin 32, or a backsplash 34. In another preferred embodiment, the vanity top includes a sidesplash 36. The sidesplash may be integral to the vanity top, or molded separately and secured to the vanity top. Either or both sides of the vanity top may be equipped with a sidesplash. Those skilled in the art will appreciate that a sidesplash may comprise multiple pieces adapted to the shape of the vanity top, for example, where a vanity top is not rectangular.

The composite polyurethane resin comprises a polyurethane resin mixed with filler. The unfilled polyurethane resin may be expandable or non-expandable. Preferably, the density of the polyurethane resin is greater than about 50 lb/ft³, most preferably from about 65 to about 85 lb/ft³. The polyurethane resin is preferably formulated to provide a viscosity that releases gases readily during the manufacturing process. Preferably, the viscosity of the polyurethane resin is less than about 700 centipoise (cp), more preferably, from about 400 cp to about 600 cp.

The filler may be any material compatible with the polyurethane resin. Preferably, the filler is dry, as will be discussed in greater detail below. Preferred fillers include calcium carbonate, ground polycarbonate, other ground plastics, sawdust, particle board, MDF, sand, silica sand, construction sand, industrial sand, commercial sand, small aggregate rocks, glass, glass mirror, calcium sulfate, rubber, and combinations thereof. More preferred fillers are silica sand, calcium carbonate and commercial/industrial sand, which includes plaster sand and turf sand. The filler preferably comprises from about 10% to about 85% by weight of the backing, more preferably from about 65% to about 85% by weight, most preferably from about 70% to about 85% by weight.

The preferred particle size of the filler varies with the type of material. The sizing of particles is well known in the art, for example, by grinding or sifting. Plaster sand and turf sand are conveniently sized by sifting. The particle distribution of plaster sand is normally about 75-2400 microns, and for turf sand, about 53-1000 microns.

During the reaction of the composite resin, water in the filler will cause the urethane to expand. Because urethane expansion may affect the both the manufacturing process and the finished product, preferably, the expansion is limited to between about 0% and about 50%. More preferably the expansion is limited to from about 10% to about 30%. Expansion may be controlled by, for example, reducing the amount of water in the filler or using a non-expandable polyurethane.

The filler preferably contains less than about 10% water by weight, more preferably, less than about 5%, most preferably, less than about 3%. In an expandable polyurethane system, a lower water content typically provides a more consistent expansion of the foam. In a non-expandable polyurethane system, a low water content generally reduces urea production and associated quality problems, including brittleness, over-expansion, denting, and inadequate cure.

The filler may be premixed with either the isocyanate or polyol component of the polyurethane resin. The premixing may be performed by any means known in the art, for example by hand, or by machine in a continuous mixer or a batch mixer. Where the filler is premixed with the isocyanate, the polyol is preferably combined with the isocyanate-filler mixture within about 35 minutes to reduce urea formation. The final mixing of the urethane resin with the filler may be performed as the mold 10 is filled, for example using a injector equipped with a mixing head with mass flow-meters to control the proportions of the components. Alternatively, mixing the composite urethane resin and filling the mold 10 may be performed in two steps. The mixing may be performed by any means known in the art, for example, by hand, or by machine in a continuous mixer or a batch mixer.

In filling the mold 10 through port 40, the temperature of the mold 10 and composite urethane resin is preferably at least about 70° F., more preferably, from about 80° F. to about 110° F. and most preferably from about 95° F. to about 105° F. Preferably, the mold 10 is filled completely, but not overfilled. The mold 10 is properly filled when a small amount of the urethane resin is observed through the weep holes 38. We believe that overfilling the mold 10 may contribute to defects in the finish of the product.

After filling is complete, the vanity top is cured, preferably at about 200° F. for about 1 to 2 minutes. After reaching the peak exotherm, the vanity top is preferably allowed to cool to a temperature of approximately about 120° F. before removing the vanity top. The vanity top is then demolded and finished by methods well known in the art, for example, by sanding or grinding.

Representative filled polyurethane formulations are provided in TABLE I. All percentages of the formulations are by weight. Autopour is a polyurethane resin supplied by BASF. Badur/Multranol is a polyurethane system supplied by Bayer. Unless otherwise indicated, the fillers were not dried before use. Commercial sand has about 5% water before drying, and less than about 1% water after drying.

TABLE I

| | | | | | Density |
|---|---|---|---|---|---|
| | Resin^{a} | Filler 1 | Filler 2 | Filler 3 | (lb/ft³) |
| Dimensions | wt % | wt % | wt % | wt % | Expansion % |
| 1 31″ × 22″ × 1.5″ | Autopour | Commercial Sand | | | 77 |
| | 40.0% | 60.0% | | | 35.0% |
| 2 31″ × 22″ × 1.5″ | Autopour | Commercial Sand | | | 77 |
| | 40.0% | 60.0% | | | 35.0% |
| 3 31″ × 22″ × 1.5″ | Autopour | Silica Sand | | | 82 |
| | 40.0% | 60.0% | | | 30.0% |
| 4 31″ × 22″ × 1.5″ | Autopour | Silica Sand | | | 90 |
| | 30.0% | 70.0% | | | 30.0% |
| 5 31″ × 22″ × 1.5″ | Badur/Multranol | Silica Sand | | | 82 |
| | 40.0% | 60.0% | | | 30.0% |
| 6 31″ × 22″ × 1.5″ | Badur/Multranol | Silica Sand | | | 97 |
| | 30.0% | 70.0% | | | 20.0% |
| 7 31″ × 22″ × 1.5″ | Autopour | Commercial Sand, Dry | | | 93 |
| | 25.0% | 75.0% | | | 25.0% |
| 8 31″ × 22″ × 1.5″ | Badur/Multranol | Commercial Sand | | | 86 |
| | 25.0% | 75.0% | | | 35.0% |
| 9 31″ × 22″ × 1.5″ | Autopour | Commercial Sand | | | 90 |
| | 20.0% | 80.0% | | | 35.0% |
| 10 31″ × 22″ × 1.5″ | Autopour | Commercial Sand | Polycarbonate | | 68 |
| | 30.0% | 35.0% | 35.0% | | 30.0% |
| 11 31″ × 22″ × 1.5″ | Autopour | Commercial Sand, Dry | Polycarbonate | | 74 |
| | 30.0% | 35.0% | 35.0% | | 20.0% |
| 12 31″ × 22″ × 1.5″ | Autopour | Polycarbonate | | | 57 |
| | 30.0% | 70.0% | | | 30.0% |
| 13 31″ × 22″ × 1.5″ | Autopour | Polycarbonate | | | 64 |
| | 30.0% | 70.0% | | | 15.0% |
| 14 31″ × 22″ × 1.5″ | Autopour | Sawdust | | | 37 |
| | 40.0% | 60.0% | | | 40.0% |
| 15 31″ × 22″ × 1.5″ | Autopour | Sawdust, Dry | | | 45 |
| | 60.0% | 40.0% | | | 30.0% |
| 16 31″ × 22″ × 1.5″ | Autopour | Sawdust, Dry | | | 41 |
| | 40.0% | 60.0% | | | 30.0% |
| 17 31″ × 22″ × 1.5″ | Autopour | Commercial Sand | Saw Dust, Dry | | 60 |
| | 40.0% | 40.0% | 20.0% | | 30.0% |
| 18 31″ × 22″ × 1.5″ | Autopour | Commercial Sand, Dry | Silica Sand | | 91 |
| | 35.0% | 40.0% | 25.0% | | 20.0% |
| 19 31″ × 22″ × 1.5″ | Autopour | ATH^{b} | | | 84 |
| | 40.0% | 60.0% | | | 25.0% |
| 20 31″ × 22″ × 1.5″ | Autopour | Commercial Sand, Dry | | | 106 |
| | 25.0% | 75.0% | | | 10.0% |
| 21 31″ × 22″ × 1.5″ | Autopour | Commercial Sand | Silica Sand | Calcium Carbonate | 95 |
| | 40.0% | 25.0% | 25.0% | 10.0% | 10.0% |
| 22 31″ × 22″ × 1.5″ | Autopour | Calcite, Dry | | | 100 |
| | 35.0% | 65.0% | | | 10.0% |
| 23 31″ × 22″ × 1.5″ | Autopour | Commercial Sand | | | 86 |
| | 25.0% | 75.0% | | | 35.0% |
| 24 17″ × 19″ × ⅜″ | Autopour | Commercial Sand | | | 86 |
| | 25.0% | 75.0% | | | 35.0% |
| 25 96″ × 22″ × 1.25″ | Autopour | Commercial Sand | | | 86 |
| | 25.0% | 75.0% | | | 35.0% |
| 26 17″ × 19″ × ¼″ | Autopour | Commercial Sand | | | 86 |
| | 25.0% | 75.0% | | | 35.0% |
| 27 12″ × 12″ × 0.5″ | Autopour | Commercial Sand, Dry | | | 77 |
| | 50.0% | 50.0% | | | 25.0% |
| 28 12″ × 12″ × 0.5″ | Autopour | Commercial Sand, Dry | | | 93 |
| | 25.0% | 75.0% | | | 25.0% |
| 29 12″ × 12″ × 0.5″ | Autopour | Commercial Sand, Dry | | | 90 |
| | 20.0% | 80.0% | | | 35.0% |
| 30 22″ × 25″ × 1.5″ | Autopour | Commercial Sand, Dry | | | 90 |
| | 20.0% | 80.0% | | | 35.0% |
| 31 12″ × 12″ × 0.5″ | Badur/Multranol | Silica Sand | | | 86 |
| | 50.0% | 50.0% | | | 15.0% |
| 32 12″ × 12″ × 0.5″ | Badur/Multranol | Silica Sand | | | 102 |
| | 25.0% | 75.0% | | | 20.0% |
| 33 12″ × 12″ × 0.5″ | Badur/Multranol | Silica Sand | | | 102 |
| | 20.0% | 80.0% | | | 25.0% |
| 34 12″ × 12″ × 0.5″ | Badur/Multranol | Silica Sand - Dry | | | 116 |
| | 20.0% | 80.0% | | | 10.0% |

^{a}Autopour supplied by BASF; Badur/Multranol supplied by Bayer.
^{b}Aluminum trihydrate.

### EXAMPLE 1

This example corresponds to Entry 1 in TABLE I. In this example, the filler in the urethane composite was commercial sand with a maximum particle size of 350 microns. The urethane composite was mixed by hand.

A 31″×22″×1.5Δ two-piece mold was opened and the interior sprayed with a 40-mil layer of polyester surface material (Safas). The gelcoat was catalyzed with about 1.75% by weight MEKP catalyst. The surface material was allowed to semi-cure until the surface was still soft to the touch, about 10 minutes, whereupon, the mold was closed and clamped firmly.

A composite was prepared from 4.85 lb of urethane system resin component (polyol) (Autopour 9594, BASF), 4.85 lb of MDI (Autopour 931-2113 Isocyanate, BASF), and 14.6 lbs of industrial sand with a maximum particle size of 350 microns. First, the polyol and industrial sand were hand-mixed in a 5-gallon pail. Second, the MDI was added to the mixture and mixed for approximately 20 seconds. Next, the composite was poured through the drain opening of the mold and allowed to cure for approximately 25 minutes after which the vanity top was removed from the mold. The flash on the finished part was sanded and ground to provide flat outer edges. The finished part had a very hard cultured marble-like finish and sound. Tapping by hand produced a sound similar to tapping solid stone or solid wood. The urethane composite product chipped less than a standard cultured marble product.

### EXAMPLE 2

This example corresponds to Entry 2 in TABLE I. A three-piece mold for a 31″×22″×1.5″ vanity top with an integral bowl and backsplash was cleaned and mounted in a mold carrier. The mold was opened. A 40-mil thick layer of a polyester surface material (Granicoat, Safas) and 1.75% catalyst was applied with a sprayer (Model 7N, Binks) to the interior surfaces of the mold. The mold was closed and the surface material partially cured for 10 minutes at 80° F. A two-component mixer (Autopour, BASF) equipped with a static mixing head was charged with mixture of 12.1 lb of industrial sand and 8.1 lb of urethane (Autopour, BASF). The urethane composite resin was heated to 90° F. with the inline heaters supplied with the mixer. The polyurethane composite resin was injected into the mold and air released until a small amount of polyurethane was observed in the weepholes. The vanity top was cured at 185° F. for 5 minutes,, allowed to cool, and demolded. Flash was cleaned from the finished top by sanding. The density of the vanity top was 77 lb/ftl³. Tapping by hand produced a sound similar to tapping solid stone or solid wood.

### EXAMPLE 3

This example corresponds to Entry 8 of TABLE I. A three-piece mold for a 31″×22″×1.5″ vanity top with an integral bowl and backsplash was cleaned and mounted in a mold carrier. The mold was opened. A 40-mil thick layer of polyester surface material (Granicoat, Safas) and 1.75% catalyst (Binks) was applied with a sprayer to the interior surfaces of the mold. The mold was closed and the surface material partially cured for 10 minutes at 80° F. A two-component mixer (Autopour, BASF) equipped with a static mixing head was charged with mixture of 12.1 lb of industrial sand and 8.1 lb of urethane (Autopour, BASF). The urethane was maintained at 90° F. with the inline heaters supplied with the mixer. The polyurethane composite resin was injected into the mold in pre-determined amounts and air released until a small amount of polyurethane was observed in the weepholes. The vanity top was cured at 185° F. for 5 minutes, allowed to cool, and demolded. Flash was cleaned from the finished top by sanding. The density of the vanity top was 86 lb/ft³.

### EXAMPLE 4

This example corresponds to Entry 18 of TABLE I. A three-piece mold for a 31″×22″×1.5″ vanity top with an integral bowl and backsplash was cleaned and mounted in a mold carrier. The mold was opened. A 40-mil thick layer of polyester surface material (Granicoat, Safas) and 1.75% catalyst (Binks) was applied with a sprayer to the interior surfaces of the mold. The mold was closed and the surface material partially cured for 10 minutes at 80° F. A two-component continuous caster was charged with mixture of 12.1 lb of commercial sand and 8.1 lb of urethane (Autopour, BASF). The urethane was maintained at 90° F. with the inline heaters supplied with the caster. The polyurethane composite resin was injected into the mold in pre-determined amounts and air released until a small amount of polyurethane was observed in the weepholes. The vanity top was cured at 185° F. for 5 minutes, allowed to cool, and demolded. Flash was cleaned from the finished top by sanding. The density of the vanity top was 91 lb/fl³.

### EXAMPLE 5

This example corresponds with Entry 28 of TABLE I. To the inside surface of a 12″×12″×0.5″ one-piece (open) mold was applied by spraying a 30-mil layer of a polyester surface material (white gelcoat, AOC). The surface material was catalyzed with 1.75% MEKP (Binks). The surface material was semi-cured in an oven at 160° F. for about 15 minutes, whereupon the surface material was still soft to the touch.

Urethane resin system component (polyol) (0.50 lb, Autopour, BASF) and of MDI (0.40 lb, Isocyanate, BASF) were heated for 30 minutes in a 132° F. oven. Commercial sand (2.70 lb) was dried for 30 minutes at 130° F. The urethane resin and MDI were removed from the oven and mixed for about 30 seconds. The commercial sand was added and the entire mixture was mixed an additional 60 seconds. The composite mixture was placed into the mold, and vibrated to remove any air, and leveled. The part was cured for about 15 minutes, allowed to cool, and demolded.

### EXAMPLE 6

This example corresponds with Entry 33 of TABLE I. To the inside surface of 12″×12″×0.5″ one-piece (open) mold was applied by spraying a 40-mil layer of a polyester surface material (Granicoat, Safas). The surface material was catalyzed with about 175% MEKP (Binks). The surface material was semi-cured in an oven at 160° F. for about 15 minutes, whereupon the surface material was still soft to the touch.

Urethane resin system component (polyol) (0.41 lb, Badur/Multranol, Bayer) and of MDI (0.34 lb, Badur 645 Isocyanate, Bayer) were heated for 30 minutes in a 133° F. oven. Commercial sand (3.00 lb) was dried for 30 minutes at 123° F. The urethane resin and MDI were removed from the oven and mixed for about 30 seconds. The commerical sand was added and the entire mixture was mixed an additional 60 seconds. The composite mixture was placed into the mold, vibrated to remove any air, and leveled. The part was cured for about 15 minutes, allowed to cool, and demolded.

The embodiments illustrated and described above are provided as examples of certain preferred embodiments of the present invention. Various changes and modifications can be made to the embodiments presented herein by those skilled in the art without departure from the spirit and scope of this invention, the scope of which is limited only by the claims appended hereto.

what is claimed is:

1. A molded vanity top comprising a surface layer and a backing, wherein the backing comprises a polyurethane resin and a filler.

2. The molded vanity top of claim 1, wherein the surface layer is a polyester-based resin.

3. The molded vanity top of claim 1, wherein the surface layer is a polyurethane-based resin.

4. The molded vanity top of claim 1, wherein the polyurethane resin is an expandable polyurethane resin.

5. The molded vanity top of claim 1, wherein the polyurethane resin is a non-expandable polyurethane resin.

6. The molded vanity top of claim 1, wherein the unfilled polyurethane resin has a density of greater than about 50 lb/ft³.

7. The molded vanity top of claim 6, wherein the polyurethane resin has a density of from about 65 lb/ft³ to about 85 lb/ft³.

8. The molded vanity top of claim 1, wherein the filler is selected from the group consisting of calcium carbonate, ground polycarbonate, other ground plastics, sawdust, particle board, MDF, sand, plaster sand, turf sand, silica sand, construction sand, industrial sand, commercial sand, small aggregate rocks, glass mirror, calcium sulfate, rubber, and combinations thereof.

9. The molded vanity top of claim 8, wherein the filler is sand.

10. The molded vanity top of claim 9, wherein the filler is plaster sand or turf sand.

11. The molded vanity top of claim 9, wherein the filler is silica sand.

12. The molded vanity top of claim 8, wherein the filler is calcium carbonate.

13. The molded vanity top of claim 1, wherein the filler comprises from about 10% to about 85% by weight of the backing.

14. The molded vanity top of claim 13, wherein the filler comprises from about 65% to about 85% by weight of the backing.

15. The molded vanity top of claim 1, wherein the density of the vanity top is from about 30 lb/ft³ to about 130 lb/ft³.

16. The molded vanity top of claim 15, wherein the density of the vanity top is from about 45 lb/ft³ to about 110 lb/ft³.

17. The molded vanity top of claim 16, wherein the density of the vanity top is from about 80 lb/ft³ to about 110 lb/ft³.

18. The molded vanity top of claim 1, wherein the vanity top is from about 0.25 inches to about 2 inches thick.

19. The molded vanity top of claim 1 further comprising an integral bowl.

20. The molded vanity top of claim 1 further comprising a backsplash.

21. The molded vanity top of claim 1 further comprising an integral bowl and a backsplash.

22. The molded vanity top of claim 1 further comprising a sidesplash produced in a separate mold.

23. A molded vanity top comprising a polyester-based resin surface layer and a backing, wherein the backing comprises from about 35% to about 15% by weight of a polyurethane resin and from about 65% to 85% by weight of sand.

24. A molded vanity top comprising a polyurethane-based resin surface layer and a backing, wherein the backing comprises from about 35% to 15% by weight of a polyurethane resin and from about 65% to 85% of sand.

25. A method of manufacturing a molded vanity top comprising applying a surface layer to an interior surface of a mold and filling the mold with a composite backing material, wherein the backing material comprises a polyurethane resin and a filler, and wherein the polyurethane resin comprises a isocyanate and a polyol.

26. The method of claim 25, wherein the mold is a closed mold.

27. The method of claim 25, wherein the mold comprises a weephole.

28. The method of claim 27, wherein the mold is filled until a small amount of the backing material is visible in the weephole.

29. The method of claim 25, wherein the backing material is injected into the mold.

30. The method of claim 29, wherein the backing material is mixed and injected with a mixing head.

31. The method of claim 29, wherein the backing material is mixed and injected with a continuous caster.

32. The method of claim 25, wherein the filler is premixed with the polyol.

33. The method of claim 25, wherein the mold oriented in a horizontal position.

34. The method of claim 25, wherein the mold is oriented in an inclined position.

35. The method of claim 25, wherein the surface layer is a polyester-based resin.

36. The method of claim 25, wherein the surface layer is polyurethane-based resin.

37. The method of claim 25, wherein the polyurethane resin is an expandable polyurethane resin.

38. The method of claim 25, wherein the polyurethane resin is a non-expandable polyurethane resin.

39. The method of claim 25, wherein the unfilled polyurethane resin has a density of greater than about 50 lb/ft³.

40. The method of claim 39, wherein the polyurethane resin has a density of from about 65 lb/ft³ to about 85 lb/ft³.

41. The method of claim 25, wherein the filler is selected from the group consisting of calcium carbonate, ground polycarbonate, other ground plastics, sawdust, particle board, MDF, sand, plaster sand, turf sand, silica sand, construction sand, industrial sand, commercial sand, small aggregate rocks, glass mirror, calcium sulfate, rubber, and combinations thereof.

42. The method of claim 41, wherein the filler is sand.

43. The method of claim 42, wherein the filler is plaster sand or turf sand.

44. The method of claim 42, wherein the filler is silica sand.

45. The method of claim 41, wherein the filler is calcium carbonate.

46. The method of claim 25, wherein the filler comprises from about 10% to about 85% of the backing.

47. The method of claim 46, wherein the filler comprises from about 65% to about 85% by weight of the backing.

48. The method of claim 25, wherein the density of the vanity top is from about 30 lb/ft³ to about 130 lb/ft³.

49. The method of claim 48, wherein the density of the vanity top is from about 45 lb/ft³ to about 110 lb/ft³.

50. The method of claim 49, wherein the density of the vanity top is from about 80 lb/ft³ to about 110 lb/ft³.

51. The method of claim 25, wherein the vanity top is from about 0.25 inches to about 2 inches thick.

52. The method of claim 25, wherein the vanity top comprises an integral bowl.

53. The method of claim 25, wherein the vanity top comprises a backsplash.

54. The method of claim 25, wherein the vanity top comprises an integral bowl and a backsplash.

55. The method of claim 25, wherein the vanity top comprises a molded sidesplash produced in a separate mold.

56. A method of manufacturing a molded vanity top comprising spraying a polyester-based resin surface layer onto an interior surface of a closed mold; closing the mold; mixing and injecting a composite backing material into the mold with a continuous caster, wherein the backing comprises from about 35% to about 15% by weight of a polyurethane resin and from about 65% to about 85% of sand, and wherein the polyurethane resin comprises a isocyanate and a polyol; curing the backing material; and demolding the vanity top.

57. A method of manufacturing a molded vanity top comprising spraying a polyurethane-based resin surface layer onto an interior surface of a closed mold; closing the mold; mixing and injecting a composite backing material into the mold with a continuous caster, wherein the backing comprises from about 35% to about 15% by weight of a polyurethane resin and from about 65% to about 85% of sand, and wherein the polyurethane resin comprises a isocyanate and a polyol; curing the backing material; and demolding the vanity top.
